(19) United States
(12) Patent Application Publication
(10) Pub. No.: US 2019/0243541 A1
(43) Pub. Date: Aug. 8, 2019

(54) System and method for reactive geo-temporal digital content navigation

(71) Applicant: Tracey Bushman, Holladay, UT (US)

(72) Inventor: Tracey Bushman, Holladay, UT (US)

(21) Appl. No.: 16/250,173

(22) Filed: Jan. 17, 2019

(51) Int. Cl. G06F 3/0488; G06F 3/0484; G06F 3/0485; G06F 3/0482

(52) U.S. Cl. CPC G06F 3/04886; G06F 3/04845; G06F 3/04847; G06F 3/0482; G06F 3/0485

(57) ABSTRACT

A user interface system and method for incrementally scrolling through content in an order determined by on-the-fly Geo-temporal correlation calculations in the browser among distinct documents, each possessing time-range and geographic coordinate values. The system and method are characterized by a single-touch analogue interaction with a prominently positioned user interface button, effectively repositioning said button in a dragging analogue gesture parallel and orthogonal direction to the timeline. The contents of the timeline are user interface modules, activated in the main display frame in reaction to said button interaction. The result of each interaction updates the visualization so that the content, represented time-range value, and represented geographic coordinate position of the active document is marked by said button in its rendering-constant on-screen position.

### DETAILED DESCRIPTION AND SPECIFICATION OF THE INVENTION

The invention, described and demonstrated as a method of interaction and subsequent visualization of temporal and other graphical content on an interactive map prototype with JavaScript, Leaflet.js, and Vue.js, is not limited in potential implementation to those programming languages, libraries, or frameworks.

The interactivity described herein centers primarily around a user-interface button-style graphic, heretofore referred to as the button.

The invention herewith describes single-touch events and their analogues emitted on all graphical user interface systems, with references corresponding as follows:

touchstart as an equivalent to mousedown

touchmove as an equivalent to mousemove, referred to as dragging when repositioning the button

touchend as an equivalent to mouseup, referred to as release

The initial interaction with the button, herein described as touchstart, initiates movement of the button along orthogonal axes, heretofore referred to as the repositioning of the button

Repositioning of the button triggers activation of a dragging state in the rendering component.

The orthogonal motion of the button activates incremental paging through content in the active dataset

Parallel repositioning of the button with the timeline incrementally activates documents according to sorting order of their time range values page

Perpendicular repositioning of the button from the timeline incrementally activates documents from a list of documents from said dataset, which are determined to be both temporally and geographically correlated in terms of each document's time-range values and geographic coordinates, respectively, with the active document.

In reaction to repositioning the button, the underlying map automatically pans so that the button marks the active document's geographic coordinate-bounded centroid, while remaining reposition-able.

The timeline automatically repositions so that the button marks the active document's associated timeline module, while remaining manually reposition-able.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO A COMPUTER PROGRAM LISTING APPENDIX

The contents of a separately-submitted computer program appendix, duplicated onto two compact discs, is referenced herewith:

index.html

main.js

style.css

scripts/(supportive scripts, comprising Leaflet.js, Vue.js, and jQuery

images/(supportive images,

### STATEMENT REGARDING PRIOR DISCLOSURES BY THE INVENTOR OR A JOINT INVENTOR

A prototype by the inventor has been in development for approximatelyfour rs, hosted at https://pu.bli.sh, by the inventor.

### BACKGROUND OF THE INVENTION

Experts in digital content navigation are increasingly incorporating Geographic User Interfaces to convey real dimensions for information, including the emergent practice of coupling geographic visualization with temporal visualization (Craig et al) (http://spacea.ndtime.wsiabato. info), The proposed invention provides a system and method for browsing content according to similarities in time-range and geographic coordinates. The proposed invention is intended to adapt to a range of information contexts for general use as an integrated user interface system. The proposed invention is enabled through front-end reactivity in browsers, resulting in a scrolling paradigm to augment or supplant customary scrolling methods.

### BRIEF SUMMARY OF THE INVENTION

The invention enables simple paging, scrolling, browsing, or otherwise incrementing the prominent display of digital content according to Geo-temporal correlation among documents with Geo-temporal values. In practical terms, any data could adapt to the user interface model in the proposed invention if it includes documents each possessing a time-range value and geographic coordinate value.

### REFERENCE TO THE DRAWINGS

The broken line and diagonal-line-shaded components rendered in each illustration indicate supportive technologies for illustrative purposes only and form no part of the claimed design.

FIG. 1 points to the tangible components of the invention, comprising:

01: The button, demarcating, singularly, a confluence of active document characteristics

02: Timeline modules, each associated with a document from a dataset

03: An example of an active document's timeline module

04: An example of an active document frame

05: A representation of a list of documents correlated with the active document

FIG. 2A illustrates the initialization of the method of interaction with the button, touchstart.

FIG. 2B illustrates the orthogonal dragging of the button away from the timeline, further initializing the scrolling of correlated documents as introduced by FIG. 1.05.

FIG. 2C illustrates an example interaction whereby the position of the dragging button determines the activation of a correlated document in the active document frame introduced by FIG. 1.04.

FIG. 3A illustrates the parallel dragging of the button with the timeline, further initializing the scrolling of timeline modules.

FIG. 3B illustrates the state of the user interface upon completion of the dragging action referenced in paragraph 0012.

FIG. 3C-3E are illustrations of the user interface outcome from repeating the steps outlined in paragraphs 0021 and 0022, further along the timeline.

FIG. 4A illustrates two alternative embodiments: one is mobile-responsive and one is mobile-responsive with a different type of temporal data represented.

FIG. 4B illustrates a further embodiment for the invention, accommodating a gallery-type view.

FIG. 4C illustrates a further embodiment for the invention, demonstrating horizontally-oriented timeline variants.

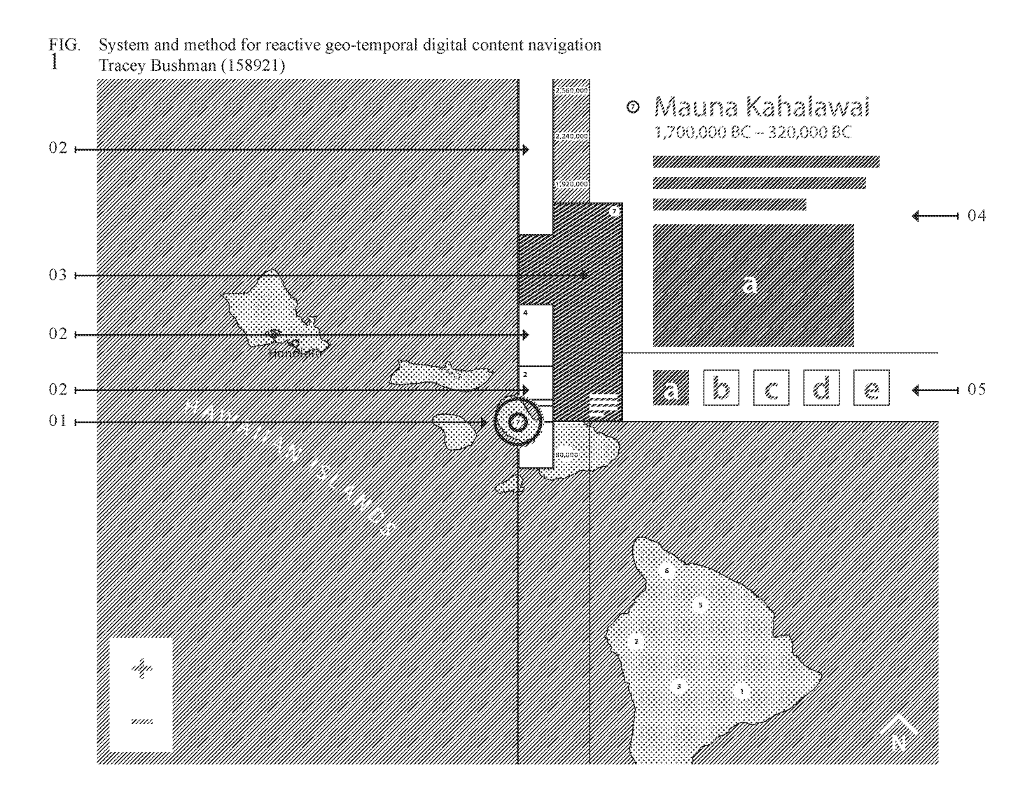

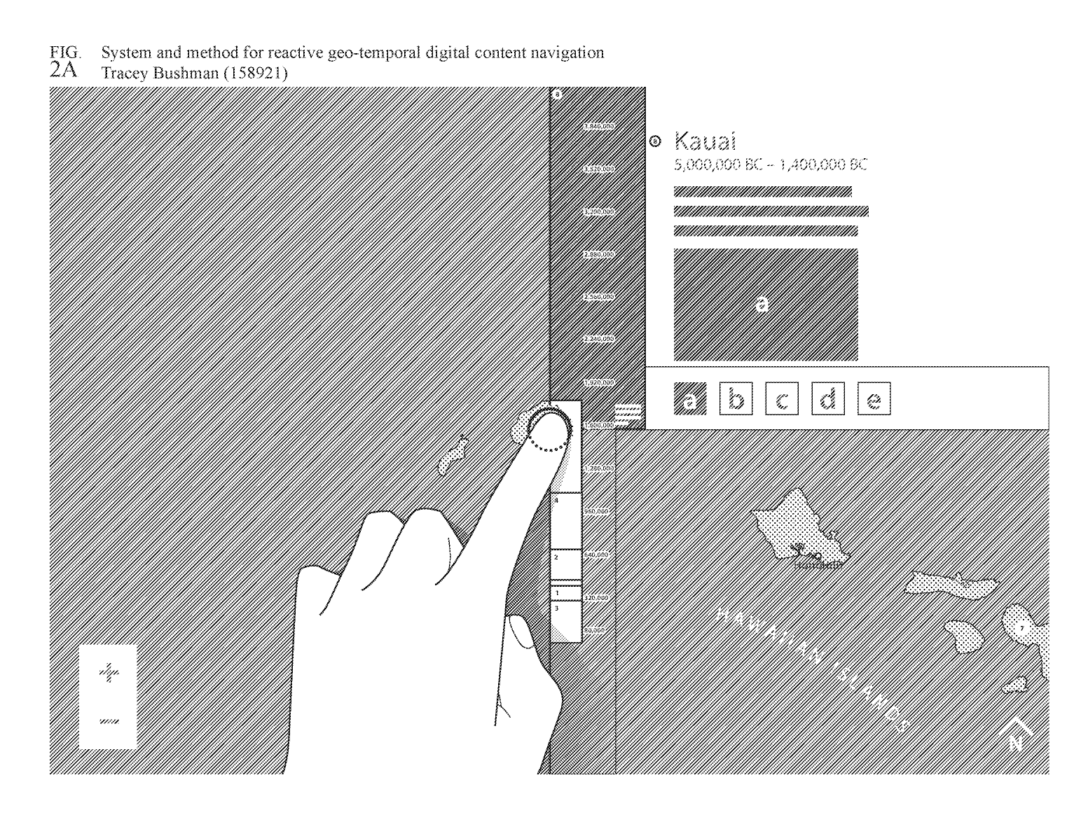

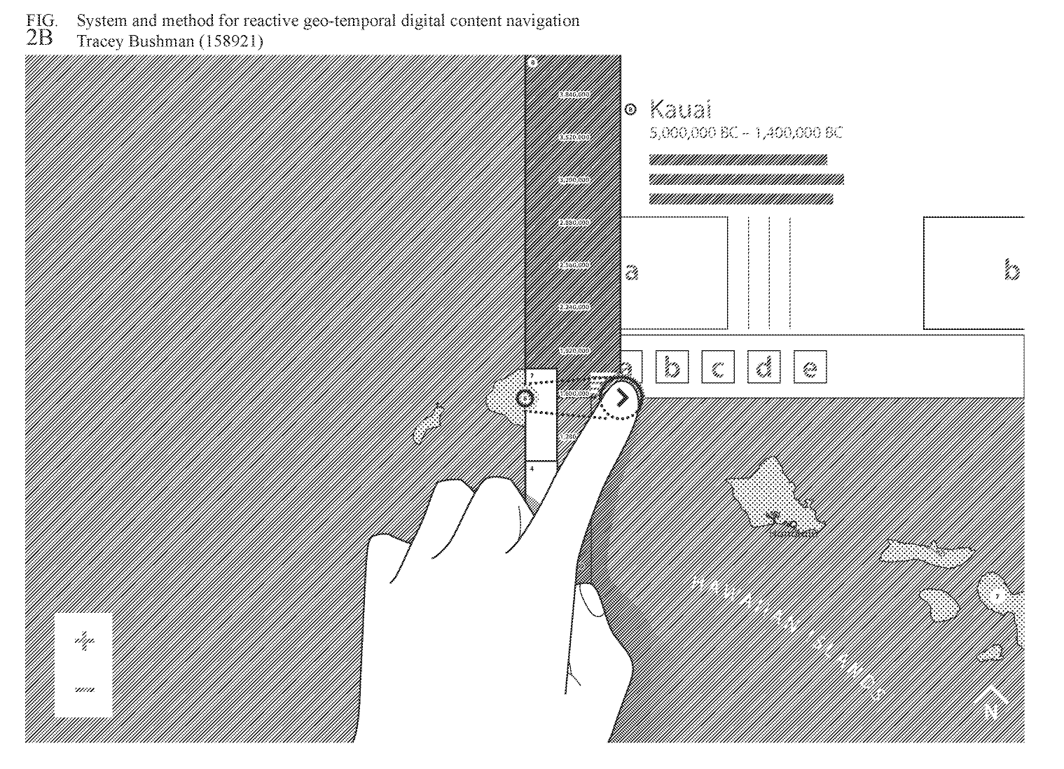

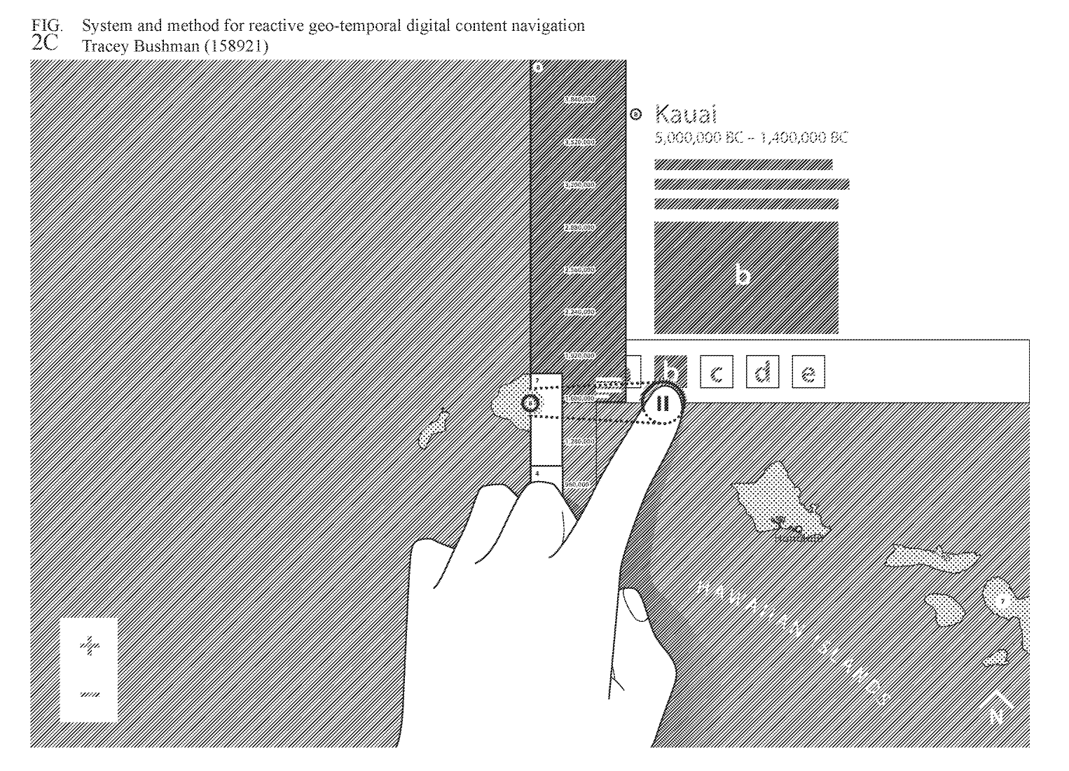

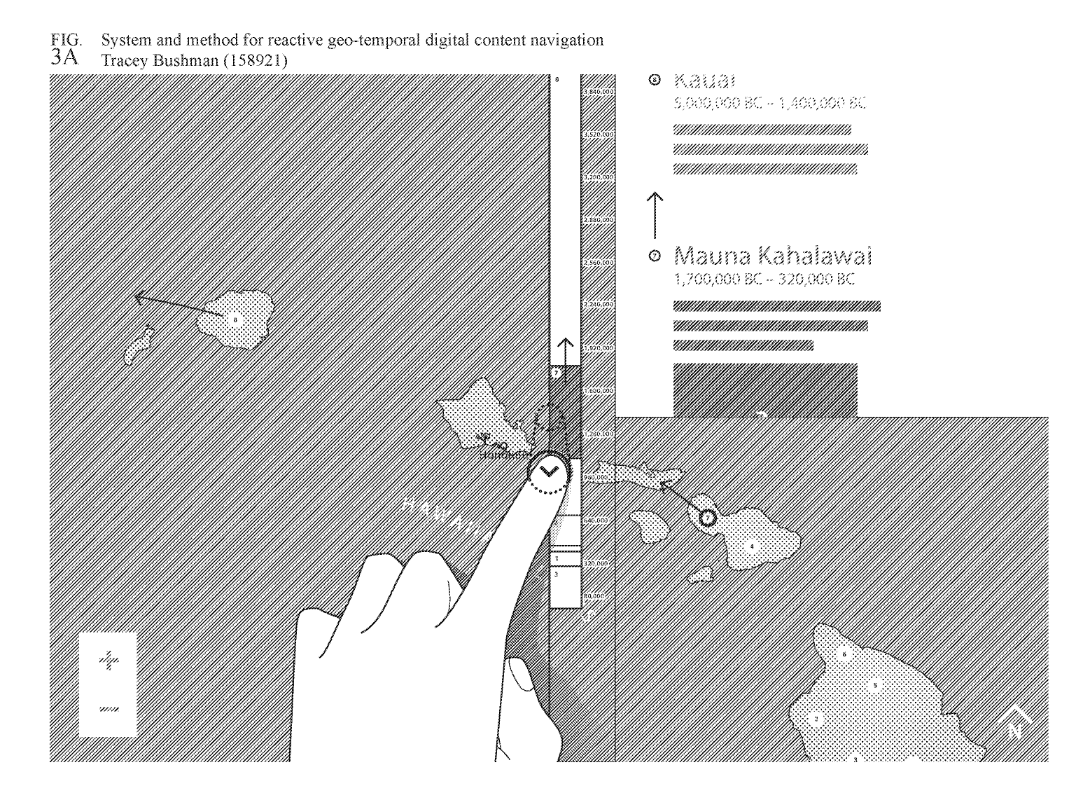

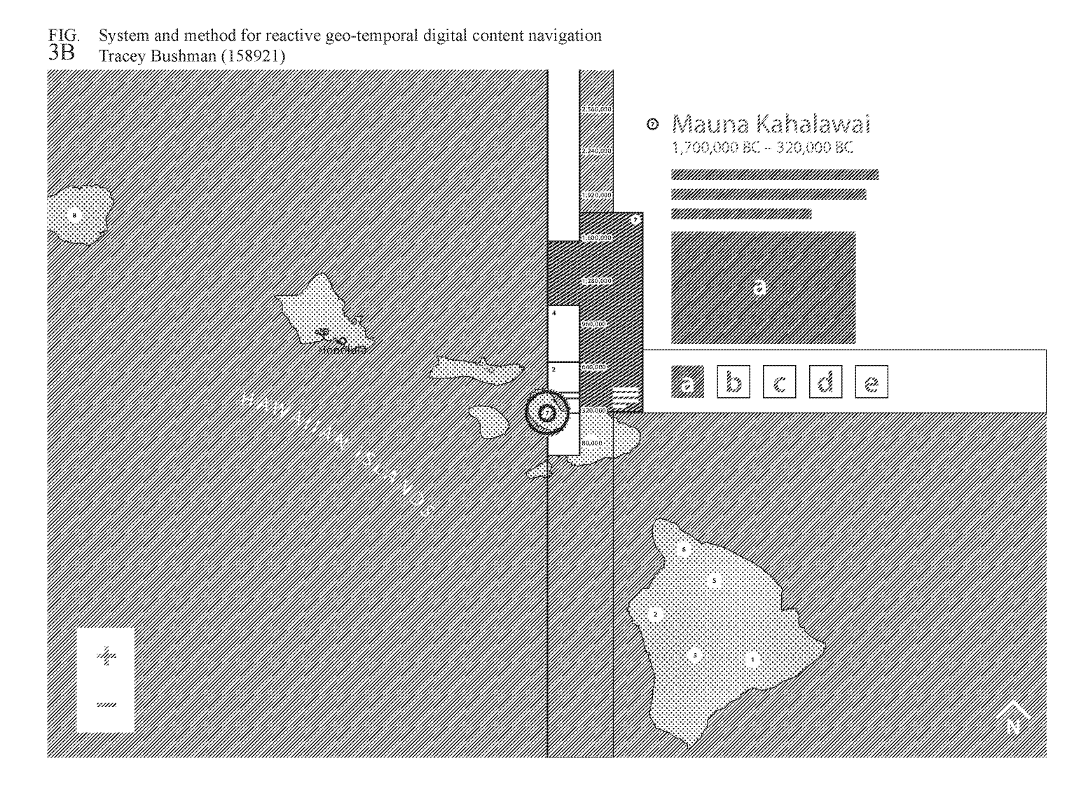

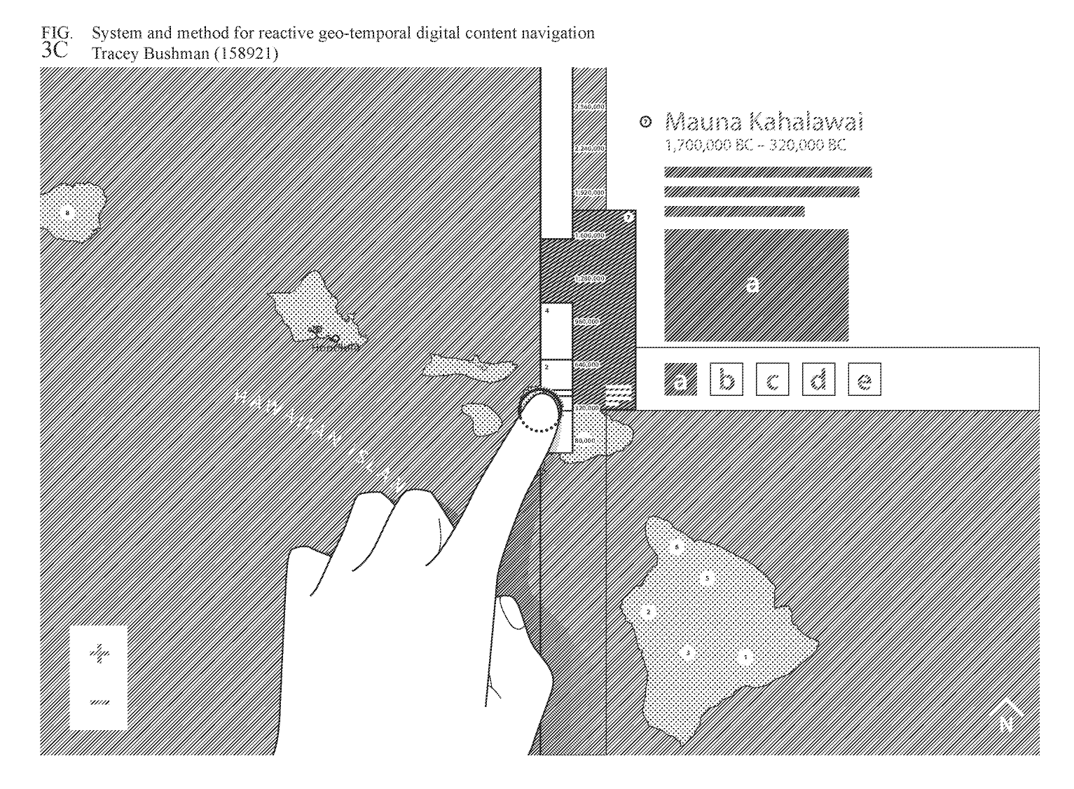

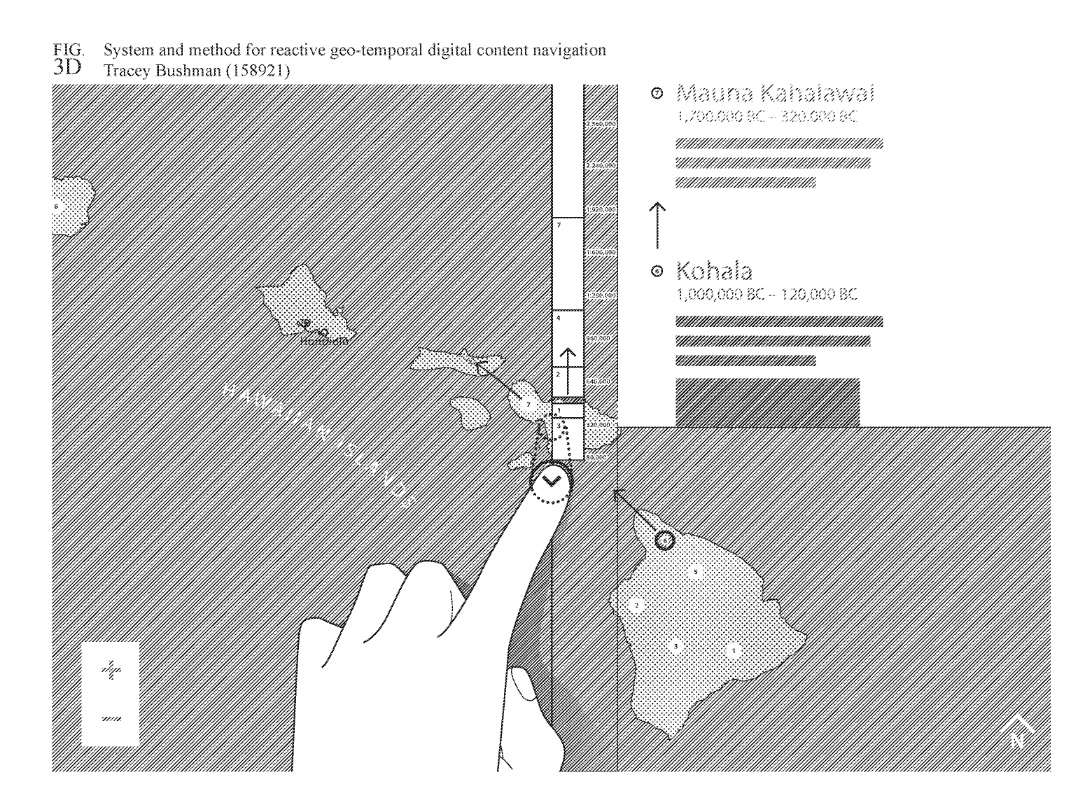

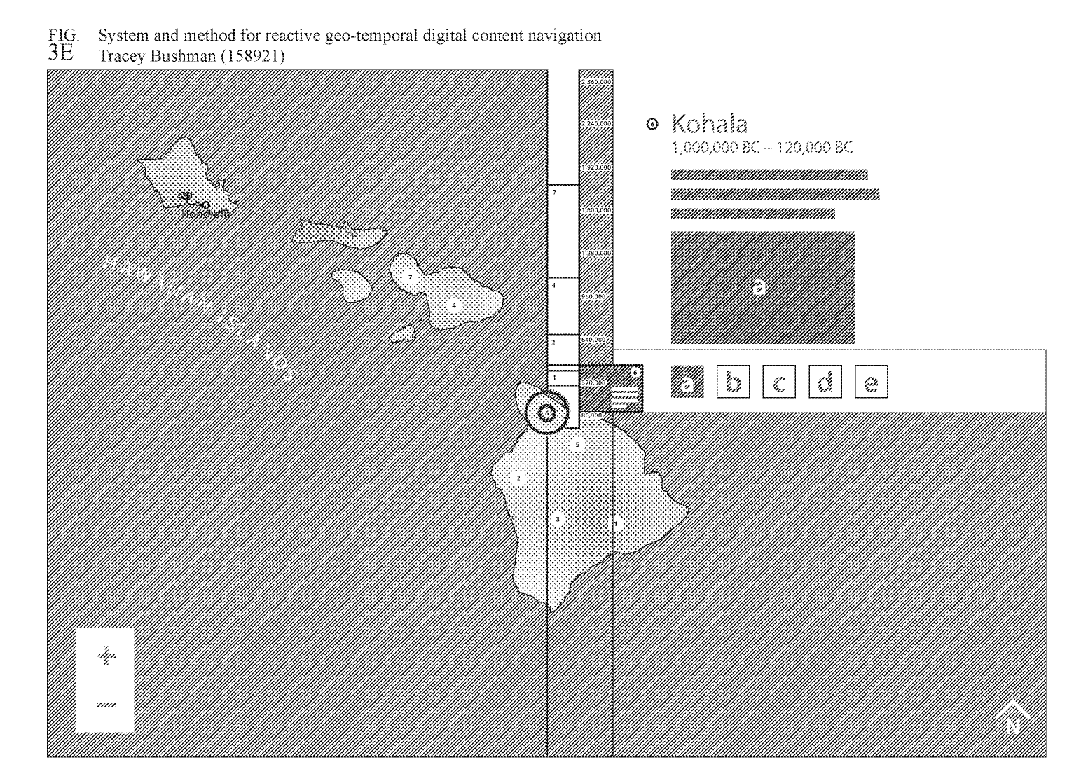

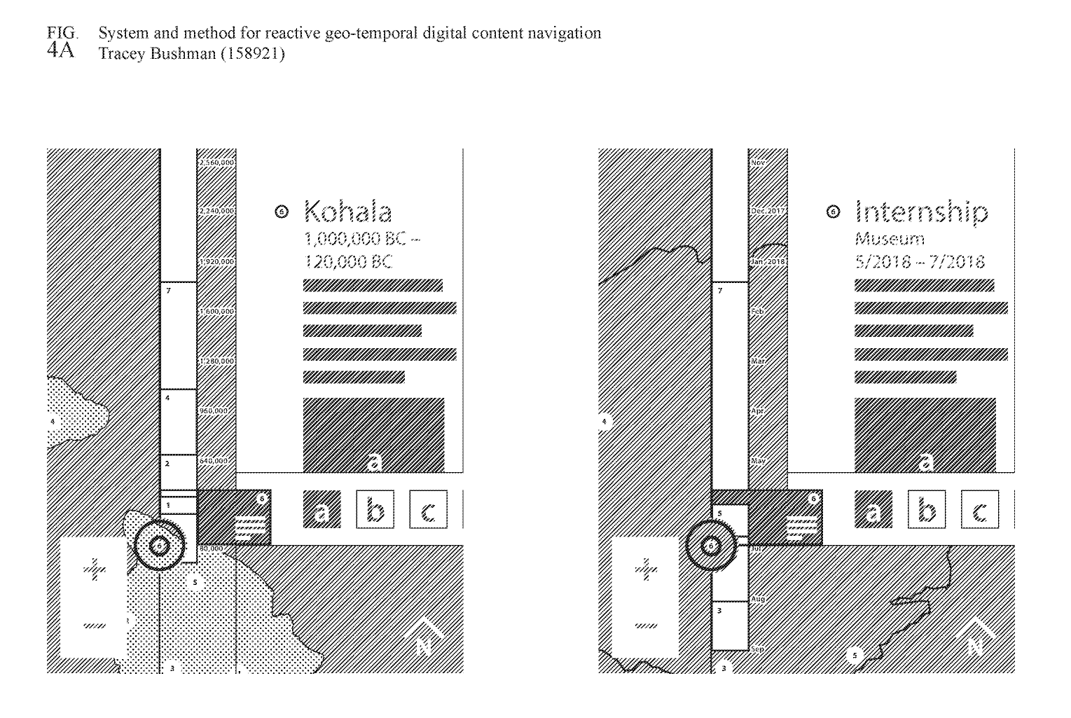

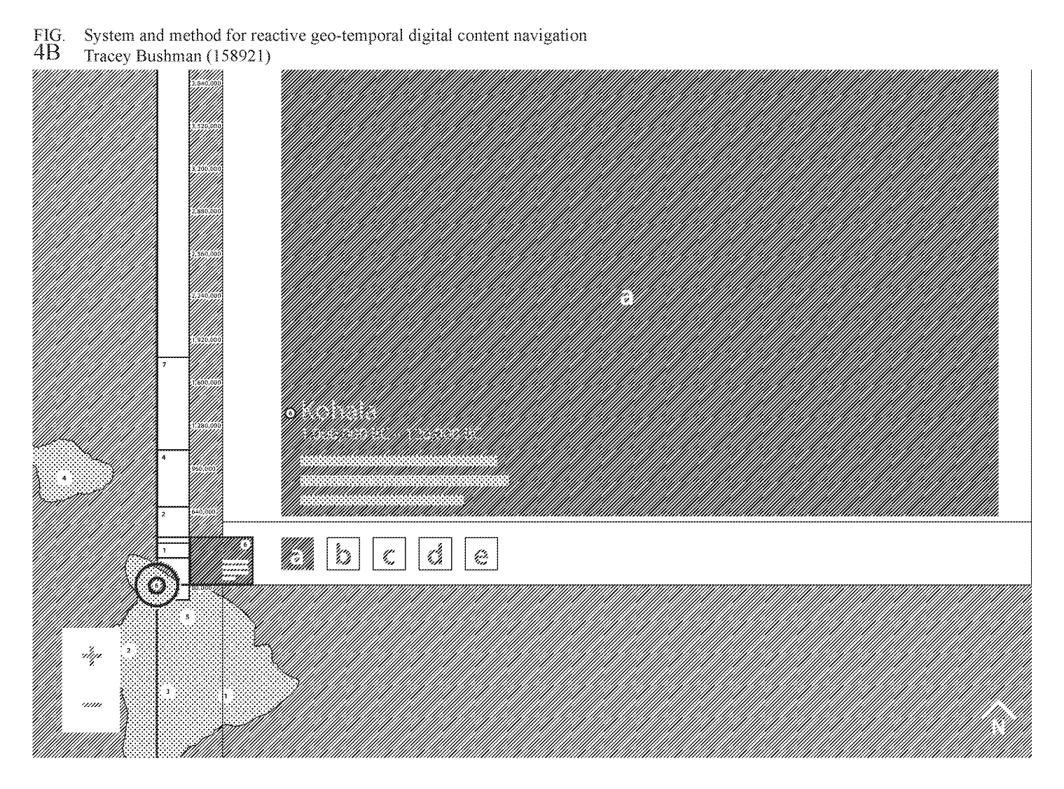

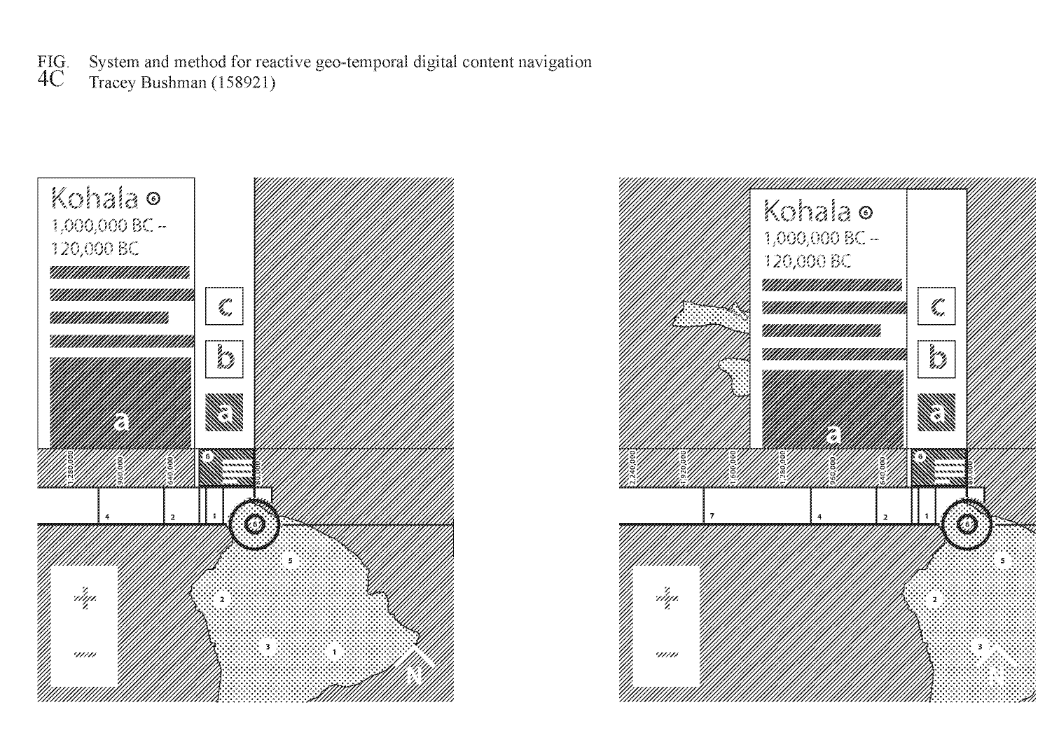

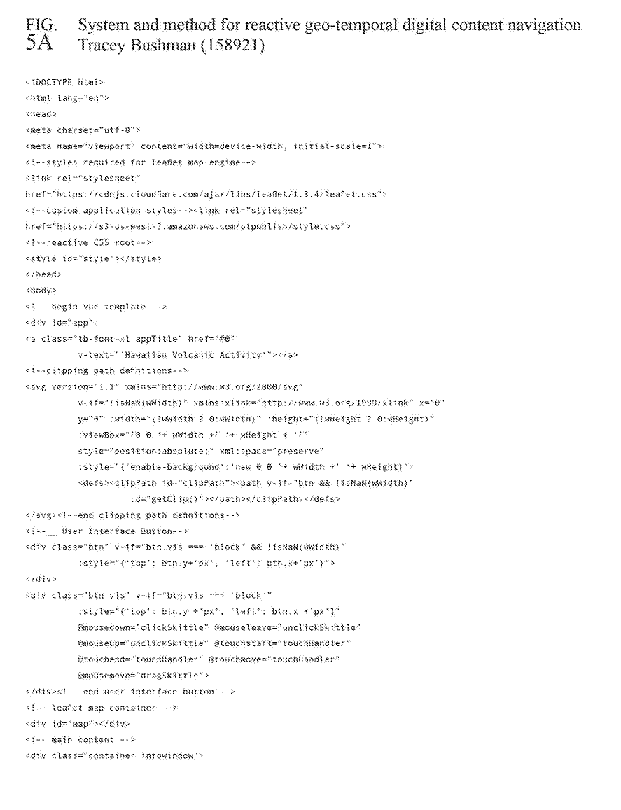

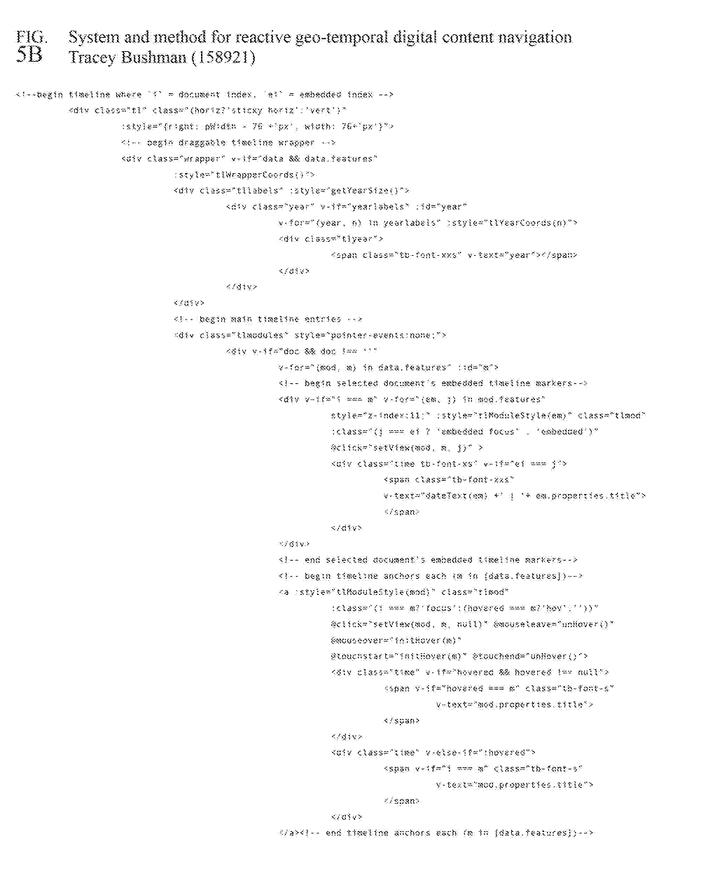

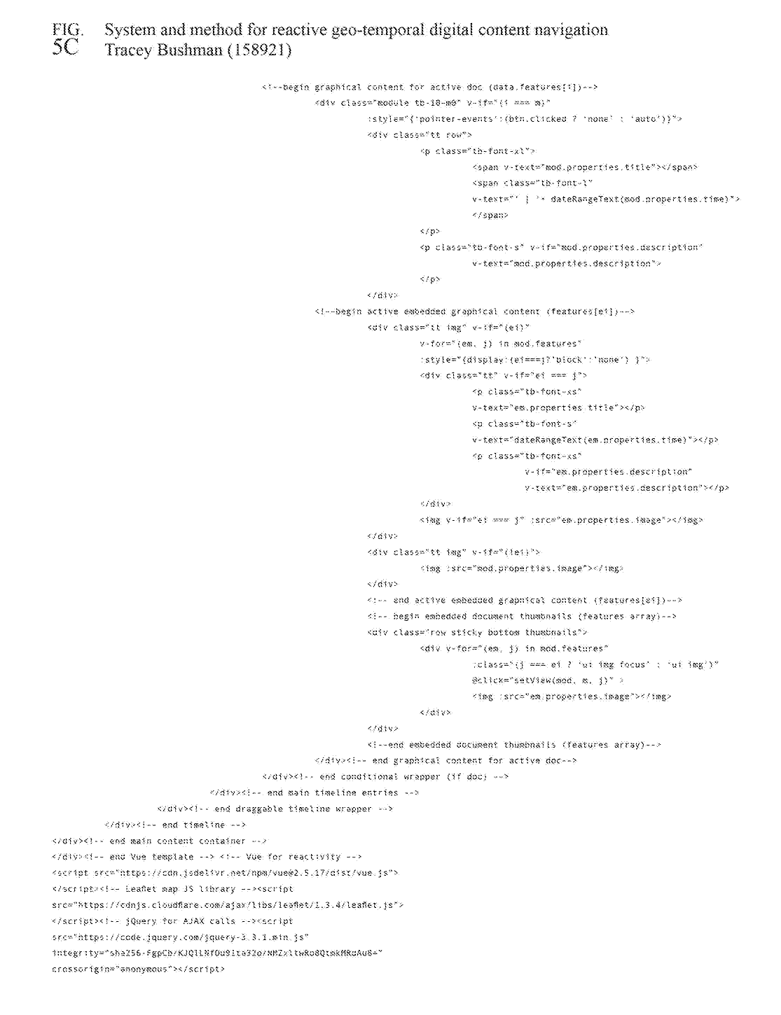

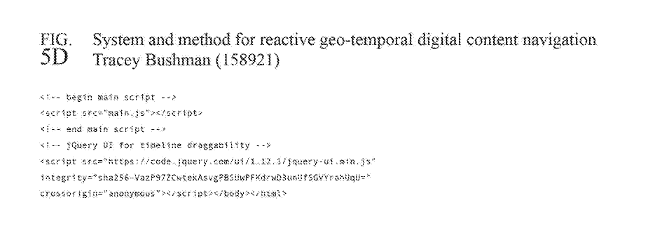

```
new Vue({ el: ‘#app’,
data( ) { return { i: 0, ei: null, map: null, dataLayer: null, c: ‘’,
          data: null, doc: null, d:‘https://s3-us-west-2.amazonaws.com‘,
          a: ‘&copy; <a href=“http://openstreetmap.org/copyright”>OpenStreetMap
  </a> &copy; <a href=“http://carto.com/attributions”>Carto</a>‘,
          t:‘http://{s}.basemaps.cartocdn.com/dark_all/{z}/{x}/{y}.png‘,
          tlwrap: { back: ‘50%’ }, shape: ‘’, hovered: null, dTimeout: ‘’,
          wWidth: window.innerWidth, wHeight: window.innerHeight,
          res: (window.innerWidth <600), infowindow: ‘tooltip’, horiz: false.
          pWidth: (!this.res ? this.wWidth / 2 : this.wWidth * 0.75),
          pHeight: (!this.res ? this.wHeight/ 2 : this.wHeight * 0.75),
          position: { lat.: (!this.map ? 19.421097 : this.map.getCenter( ).lat),
                  lng: (!this.map ? −155.286762 : this.map.getCenter( ).lng),
                  zoom: (!this.map ? 9 : this.map.getZoom( )) },
          zfactor: 0.01 * (!this.position ? 6 : (18 − this.position.zoom ) ),
          btn: { x: (!this.res ? this.wWidth / 2 : this.wWidth * 0.25),
                  y:(!this.res ? this.wHeight/ 2 : this.wHeight * 0.75), dH: false,
                  clicked: false, vis: ‘block’. dragging: false. r: 23
          }, yearsbegin: [ ], yearsend: [ ], yearstot: 0, yearlabels: [ ] } },
beforeDestroy( ) { var self = this: clearTimeout(self.dTimeout); },
beforeMount( ) { var self = this;
          self.refreshData(function(err, data){ if (!err) self.data = data; })},
mounted( ) { var self = this; // initialization scripts / calls
          self.refreshData(function(err, data){ if (!err) {
                  data.features.sort(function(a,b){
                          return (a.properties.time.end < b.properties.time.end) });
                  self.data = data;
                  self.doc = data.features[self.i];
                  self.appendStyleRoot( );
                  var mapCont = document.getElementById(‘map’);
                  if (mapCont) {
                  self.loadMap(function(dataLayer) {
                          if (dataLayer) self.dataLayer = dataLayer;
                          if (self.doc) self.setView(self.doc, self.i, self.ei);
                          $(‘.tl > .wrapper’).draggable({axis: “y”,disabled: false});
                          window.addEventListener(‘resize’, function( ){
                                  if (self.doc && self.doc !== { } && self.doc !== ‘’)
                                          self.debounceF(self.refreshTL(self.doc)) }); }); } } });
} /* end initialization scripts / calls */,
methods: { /* begin btn touch event delegation */
btnTouch(e, eTouch, eType) { var self = this, res = self.res,
          x = eTouch.pageX, y = eTouch.pageY, diffX = x − self.btn.x.
          diffY = y − self.btn.y, sW = self.wWidth, sH = self.wHeight;
          if (eType === ‘touchstart’) {
                  self.btn.clicked = true;
          } else if (eType === ‘touchmove’) {
                  if (!self.btn.dragging) {
                          if (diffX < diffY) self.btn.dH = false;
                          else self.btn.dH = true; }
                  self.btn.dragging = true;
                  self.btnMove(diffX, diffY);
          } else if (eType === ‘touchend’) {
                  self.btn.clicked = false;
                  self.btn.dragging = false;
                  self.btn.dH = false;
                  self.refreshUI( ); }}/*end btn touch event delegation*/,
/*begin debounce geotime reactivity*/
btnMove(difX, difY) { var self = this. nmTop = self.btn.y + difY,
          nmLeft = self.btn.x + difX;
          if (!self.btn.dragging) return;
          if (self.btn.dH) { self.btn.x = nmLeft;
                  it (Math.abs(difX) > 1) self.debounceF(self.tlMove(difX));
          } else { self.btn.y = nmTop;
                  if (Math.abs(difY) > 1) self.debounceF(self.tlMove(difY));
          }/*end debounce geotime reactivity*/} ,/*begin incremental tl select*/
tlMove(d) { var self = this, i = self.i, ei = self.ei, doc = self.doc,
          data = self.data;
          if (self.btn.dH) { if (self.doc.features) { if (!ei) { ei = 0; }
                  if (d < 0) { if (doc.features[ei−1]) ei−−;
                  } else { if (doc.features[ei+1]) ei++; } }
          } else { ei = null;
                  if (d < 0) { if (data.features[i−1]) i−−;
                  } else { if (data.features[i+1]) i++; }
                  doc = data.features[i];
          }
          self.setView(doc, i, ei);
}/*end incremental tl select*/,
/*begin setView -- determines active doc displayed is map / tl*/
setView(doc, i, ei) { var self = this;
          self.i = i:
          self.ei = ei;
          if (!ei) doc.features = self.containArr(doc);
          self.doc = doc;
          self.refreshTL(self.doc);
} /*determines active doc displayed in map / tl*/.
/*begin timeline / UI / map reactivity caller */
refreshTL(mod) { var self = this, ft = mod.features,
          coords = ( self.ei && ft && ft.length ? //use embedded geometry
                  ft[self.ei].geometry.coordinates :/*else*/mod.geometry.coordinates);
          self.refreshUI( ); // reactive UI
          self.recalcTL( );
          self.tlwrap.back = self.getTlWrapBack(mod);
          self.appendStyleRoot( );
          if (coords && coords[0]) self.refreshMap(self.rxArr(coords)); },
/* get features contained within a given nap Polygon and time range*/
containArr(mod) { var self = this. features;
          var t1 = mod.properties.time; // given document's time range
          var g1 = self.rxArr((!mod.features ? /* use containing doc*/
                  self.doc.geometry.coordinates : mod.geometry.coordinates));
          return self.data.features.sort( /* ensure data sorted by time range */
                  function(a,b){return a.properties.time.end < b.properties.time.end}
          ).filter(function(feature){ /*ret documents with overlapping geotime*/
                  var t2 = feature.properties.time;
                  var g2 = self.rxArr(feature.geometry,coordinates);
                  return (self.containGeo(g1, g2) && self.nearTempo(t1, t2)); }); }
                  /*end get features contained within a map polygon and time range */,
/*begin map geometry contains-checker*/
containGeo(cd1, cd2) { /* does cd1 contain cd2 ? Boolean */
          var self = this, cZF = (self.position.zoom + self.zfactor), center;
          if (!isNaN(cd1[0])) center = L.latLng(cd1);
          else center = L.latLngBounds(cd1).getCenter( );
          var buf = L.circle(center, { radius: 1400 * cZF }).addTo(self.map);
          var ll1 = buf.getBounds( ), ll2 = (
                  !isNaN(cd2[0]) ? /*Point*/cd2 : /*Polygon*/L.latLngBounds(cd2) );
          buf.remove( );
          return ll1.contains(ll2); }/*end does cd1 contain cd2 8ool*/,
/* reactive Timeline styles */ /*begin timeline contains-checker*/
nearTempo(t1, t2) { var eT = this.evalTime;
          return (eT(t2.begin) >= eT(t1.begin) && eT(t2.end) <= eT(t1.end));},
/* create arrays of time range vertices and generate labels from them */
recalcTL( ) { var self = this, mod = self.data
          self.yearsbegin = mod.features.map(function(feature){
                  return self.evalTime(feature.properties.time.begin); });
          self.yearsbegin.sort(function(a, b) { return a − b; });
          self.yearsend = mod.features.map(function(feature){
                  return self.evalTime(feature.properties.time.end); })
          self.yearsend.sort(function(a, b) { return a − b; });
          self.yearstot =
                  self.yearsend[self.yearsend.length − 1] − self.yearsbegin[0];
          self.yearlabels = self.getYearLabels( ); } /*end TL arrays / labels */,
/*begin reactive timeline positioning*/ /*position based on active doc*/
getTlWrapBack(mod) { var self = this, o = (!self.res ? 50 : 75),//origin
          tb = self.evalTime(mod.properties.time.begin),
          te = self.evalTime(mod.properties.time.end),
          cZF = (self.position.zoom * self.zfactor),
          mStart = tb − self.yearsbegin[0], mSize = te − tb;
          return (o − ((( mSize + mStart ) / this.yearstot) * cZF * 100)+‘%’);
},/*begin reactive TL style*/
tlWrapperCoords( ) { var styles = { };
          styles[(this.horiz?”minWidth”:”minHeight”)] = ‘100%’;
          styles[(this.horiz?”width”:”height”)] = ‘auto’;
          styles[(this.horiz?”minHeight”:”minWidth”)] = ‘72px’;
          styles[(this.horiz?”left”:”top”)] = this.tlwrap.back;
          return styles: }/* end reactive timeline positioning */,
tlYearCoords(n) { var styles = { }, zoom = this.position.zoom;
          styles[(this.horiz?”width”:“height”)] = ((zoom*this.zfactor) *10)+”%”;
          return styles: },
tlModuleStyle(mod) { var styles = { }, horiz = this.horiz,
          zfactor = this.zfactor, cZF = (this.position.zoom * zfactor),
          mStart = this.evalTime(mod.properties.time.begin) − this.yearsbegin[0],
            mSize = this.evalTime(mod.properties.time.end) −
                  this.evalTime(mod.properties.time.begin);
          if (this.yearsbegin.length) {
                  styles[(horiz?”left”:”top”)] = ( (mStart === 0 ? ‘0%’ ;
                          (mStart / this.yearstot) * cZF * 100 )+”%” );
                  styles[(horiz?”width”:”height”)] =
                          ((mSize / this.yearstot ) * cZF * 100) +“%”;
                  return styles;
          } else { return ‘’ } },
getYearSize( ) { var styles = { },
          cZF = (this.position.zoom * this.zfactor), int = (this.yearstot / 10),
          yL = (this.yearstot / int), yH = ((cZF * 10) * yL) + ‘%’;
          styles[(this.horiz?’width’:’height’)] = yH;
          styles[(this.horiz?’left’:’top’)] = ‘0%’;
          return styles: }/*end reactive TL style*/,/*end reactive TL position*/
/*********************** btn event handling ***************************/
touchHandler(e) { for (var i = 0; i < e.changedTouches.length − 1: i++){
          this.btnTouch(e, e.changedTouches[i], e.type); }},
mouseHandler(e) { e.preventDefault( );
          var fakeTouch = {pageX: e.pageX, pageY: e.pageY},
          eventType = ( e.type === ‘mousedown’ ? ‘touchstart’ : (
                  e.type === ‘mouseup’ || e.type === ‘mouseleave’ ?
                  ‘touchend’ : ‘touchmove’ ));
          this.btnTouch(e, fakeTouch, eventType); },
clickSkittle(e) { if (e.button === 0) this.btn.clicked = true;
          this.mouseHandler(e); }.
unclickSkittle(e) { if (this.btn.clicked) this.mouseHandler(e); },
dragSkittle(e){ if (this.btn.clicked) this.mouseHandler(e); }.
initHover(m) { this.hovered = m; },
unHover( ) { this.hovered = null; },
/*********************** Text-fetching scripts ************************/
dateText(em) { var adj , //adjust year to BC / AD
          timebegin = this.evalTime(em.properties.time.begin),
          timeend = this.evalTime(em.properties.time.end),
          thisyear = new Date( ).getFullYear( );
          var adbc = (timebegin < (thisyear * −1) ? ‘BC’ : ‘AD’);
          if (adbc === ‘AD’) { adj = thisyear + timebegin; }
          else { adj = (thisyear − timebegin) − thisyear; }
          return (adj + ‘’ + adbc); },
dateRangeText(time) { var adj, //adjust year to BC / AD
          timebegin = this.evalTime(time.begin),
          timeend = this.evalTime(time.end), thisyear = new Date( ).getFullYear( )
          var adbcBegin = (timebegin < (thisyear * −1) ? ‘BC’ : ‘AD’),
                  adbcEnd = (timeend < (thisyear * −1) ? ‘BC’ : ‘AD’);
          if (adbcBegin === ‘AD’) adj = thisyear + timebegin;
          else adj = (thisyear − timebegin) − thisyear;
          if (adbcEnd=== ‘AD’) adje = thisyear + timeend;
          else adje = (thisyear − timeend) − thisyear;
          return (adj + ‘’ + adbcBegin + ‘ − ’ + adje + ‘’ + adbcEnd); },
getYearLabels( ) { var self = this. int = (this.yearstot/10),
          wDom = document.getElementsByClassName(‘wrapper’)[0],
          wrapH = (!wDom ? 0 : wDom.getBoundingClientRect( ).height);
          return Array.from({ length: this.yearstot / int },
                  function(v, i){ return self.yearsbegin[0] + (i * int) }); },
/*************** Begin utility and maintenance scripts ***************/
rx0rNo(arr) { return ( arr[0] < a ars[1] ? arr.reverse( ) : arr ) },
rxArr(arr) {
          var self = this:
          if (!Array.isArray(arr[0])) return self.rx0rNo(arr);
          var rxa =arr.map(function(ar){ if (!Array.isArray(ar[0])) {
                  return self.rx0rNo(ar) } else if (Array.isArray(ar)) {
                          return ar.map(function(a){ if (!Array.isArray(a[0])) {
                                  return self.rx0rNo(a) } else if (Array.isArray(a)) {
                                          return a.map(function(b){ if (!Array.isArray(b[0])) {
                                                  return self.rx0rNo(b) } else if (Array.isArray(b)) {
                                                          return b.map(function(c){
                  if (!Array.isArray(c[0])) {return self.rx0rNo(c) }
                  else {return} })} else {return} })} else {return} })} else {return}
          });
          return arr; } /*Leaflet requires reversed geo-coordinate (lat, lng)*/,
evalTime(time) {/*some time ranges in data require difference calc*/
          return (Array.isArray(time) ? eval(time[0] − time[1]) : time ): },
debounceF(fn) { /* btn scroll speed */ clearTimeout(this.dTimeout);
          this.dTimeout = setTimeout(fn, 1000): },
loadFeatures(ft, cb) { var self = this, dataLayer;
          if (self.dataLayer) self.dataLayer.remove( )
          if (ft.length && self.map) { dataLayer = L.featureGroup( );
                  ft.forEach(function(f, i) {
                          var opts = { radius: 11, weight: .5. fillOpacity: 0.1,
                                  color: ‘#fff’, fillColor: ‘var(--highlight)’, opacity: 0.5 }
                          var coords = f.geometry.coordinates:
                          // geojson uses [lng, lat] and Leaflet uses [lat, lng]
                          var cd = self.rxArr(coords);
                          if (f.geometry.type === ‘Point’) {
                                  var c = L.circleMarker(cd, opts ).on(‘click’, function( ){
                                          self.setView(f, i, null)})
                                  c.addTo(dataLayer):
                          } else {var p = L.polygon(cd, opts).on(‘click’, function( ){
                                  return self.setView(f, i, null)})
                                  p.addTo(dataLayer); }}):
                  self.map.addLayer(dataLayer);
          } cb(dataLayer); } /map geatures*/,
loadMap(cb) { var self = this, dataLayer,
          map = new L.map(‘map’, {
                  maxBounds: L.latLngBounds([L.LatLng(43,−122),L.LatLng(−7,−188)]),
                  center: [self.position.lat.self.position.lng], zoomControl: false,
                  zoom: self.position.zoom, minZoom: 4, maxZoom: 18 });
          L.control.zoom({ position:’bottomleft’ }).addTo(map):
          var opts = { bounds: map.getBounds( ).pad(100), attribution: self.a };
          L.tileLayer( self.t, opts ).addTo( map);
          map.on(‘zoomend’, function( ){
                  if (self.doc) self.setView(self.doc, self.i, self.ei) });
          self.map = map;
          if (!self.dataLayer && self.data) {
                  self.loadFeatures(self.data.features, cb):
          } else { cb(map, self.dataLayer); } },
refreshMap(cd){ var self = this, lat, lng, center = self.map.getCenter( )
          if (self.shape && self.shape !== ‘’) self.shape.remove( );
          if (!cd) { lat = center.lat; lng = center.lng;
          } else if (Array.isArray(cd[0])) {
                  self.shape = L.polygon(cd).addTo(self.map);
                  lat = self.shape.getBounds( ).getCenter( ).lat;
                  lng = self.shape.getBounds( ).getCenter( ).lng;
          } else { lat = cd[0]: lng = cd[1]; }
          if (lat && lng) { let latlng = new L.LatLng(lat, lng), nl;
                  var n = self.map.latLngToLayerPoint(latlng), x = n.x. y = n.y.
                  dL = self.btn.x, dB = self.wHeight − self.btn.y;
                  if (self.res) { /* if screen width < 1000 -- responsive btn offset*/
                          nl =self.map.layerPointToLatLng(L.point((x+dL), (y−dB))};
                  } else { nl =latlng }
                  self.map.panTo(nl):
                  self.position.zoom = self.map.getZoom( ); }},
refreshUI( ) { this.wWidth = window.innerWidth: this.wHeight =
          window.innerHeight: this.pWidth = (!this.res ? (this.wWidth / 2) :
          (this.wWidth * .75)); this.pHeight = (!this.res ? (this.wHeight/2) :
          this.wHeight * 0.75); if (!this.btn.dragging) {this.btn.x=(!this.res ?
                  (this.wWidth / 2):(this.wWidth * .25)); this.btn.y=this.pHeight;} },
refreshData(cb){ $.getJSON(‘${this.d}/ptpublish/data.js‘)
          .done(function(data) { cb(null. data) })
          .catch(function(er){cb(new Error(‘internet connection required’)}}):},
getClip( ) { if (this.btn) {// make central clipping svg d value reactive
          var wW = ( !this.wWidth ? window.innerWidth : this.wWidth ),
          wH = ( !this.wHeight ? window.innerHeight : this.wHeight ),
          pW = ( !this.pWidth ? ( wW * (this.res?0.75:0.5) ) : this.pWidth ),
          pH = ( !this.pHeight ? (wH * (this.res?0.75:0.5) ) : this.pHeight ),
          r = this.btn.r, cRc = (r * 0.5523), cRr = 0.81,
          sY = (isNaN(this.btn.y)?(wH*(this.res?0.75:0.5)):this.btn.y);
          var str = ‘M${wW},${wH}H0V0h${wW}V${wH}z
          M${(wW − pW) + r},${sY}c0−${cRc}−${(cRc * cRr)}−${r}−${r}−${r}
                  c-${cRc}.0−${r},${(cRc * cRr)}−${r},${r}
          c0,${cRc},${(cRc * cRr)},${r},${r},${r}
                  C${(wW − pW) + cRc},${($Y+r)},${(wW − pW)+r},${(sY + cRc)},
                  ${((wW − pW) + r)},${sY}z‘
          return str; }},
appendStyleRoot( ) { var style = document.getElementById(‘style’):
          style.innerHTML = ‘:root {--screenW: ${this.wWidth}px; --screenh:
                  ${this.wHeight}px: --panelw: ${this.pWidth}px: --panelh:
                  ${this.pHeight}px:--panelwper:${((this.pWidth/this.wWidth)*100)}%;
                  --panelhper: ${((this.pHeight / this.wHeight) * 100)}%;}’}
}});
```

What is claimed is:

1. A System and Method for navigating digital content reactively according to geographic coordinates and time range values, comprising
a. a variable dataset of document Objects, each comprising:
i. a time range Object
ii. a geographical coordinate Array or Object
iii. textual and graphical content
the confluence of properties which, through integrated means of interaction, together determine the active or inactive state of each document
b. a variably aggregated set of documents originating from said dataset, determined to be correlated with the active document according to time-range and geographic coordinate values, and visualized as a hyperlinked list within the graphical rendering of the active document
c. a timeline represented on-screen as a graphical container scaled to the domain of time ranges aggregated from each document within said dataset and according to geographic zoom level, or Z-dimension
d. graphical timeline elements contained within the timeline, heretofore referred to as timeline modules, scaled in size and position according to corresponding documents' time ranges within the timeline's time-range domain
e. timeline positioning that adjusts so that the active document's timeline module terminates at the center point of the user interface button in its role marking the active document's active state after each rendering update, while keeping the timeline reposition-able
f. selectable geographic features, each representing geographic coordinates from corresponding documents in said dataset, on an underlying map; its centroid positioned directly beneath the user interface button after each rendering update, while remaining reposition-able.

2. The system of claim 1 wherein the on-screen repositioning of a graphical user interface button determines or demarcates which document in said dataset is active and thereby prominently visualized.

3. The method of claim 2 whereby the function of button positioning comprises:
a. dragging the centralized user interface button itself
b. touching or clicking graphical arrows on or near said button, intended to ease mouse event interactivity with said button
c. dragging the timeline under said button, thereby adjusting the timeline's position to align the active timeline module with the button
d. touching or clicking the timeline modules, thereby adjusting the timeline's position to align the active timeline module with the button
e. touching or clicking map features, thereby updating the map view to inherit the active document's centroid, further corresponding to the on-screen position of the button
f. touching or clicking anchors representing correlated documents

4. The method of claim 2 whereby said button's position along said timeline controls the scrolling and the incremental selection of documents from said dataset sorted by time-range value

5. The method of claim 2 whereby positioning said button orthogonally from said timeline controls the scrolling and reactive selection of documents from a hyperlinked list that are geo-temporally correlated with the active document

6. The method of claim 3 whereby said button may be dragged from—and will subsequently snap back to—a constant resting viewport position upon button release

7. The method of claim 4 whereby the resulting active document subsequently and reactively updates the visualization to reflect said active document's respective geospatial positioning and timeline positioning

8. The method of claim 5 whereby the resulting active document subsequently and reactively updates the visualization to reflect said active document's respective geospatial positioning and timeline positioning

9. The method of claim 6 whereby dragging said button activates documents from said dataset at intervals dependent on situations, comprising:
a. the alignment of said button within the pixel span of a timeline module or document anchor
b. a constant rate of incrementation, as prototyped in the submitted computer program appendix, and potentially coupled with device touch pressure
c. touch-move event duration and distance
